(19) United States
(12) Patent Application Publication
(10) Pub. No.: US 2016/0042024 A1
(43) Pub. Date: Feb. 11, 2016

(54) CONTINUOUS DATA HEALTH CHECK

(71) Applicant: Front Porch Digital, Inc., Lafayette, CO (US)

(72) Inventors: Brian Campanotti, Toronto (CA); Phil Jackson, Lafayette, CO (US); Geoff Tognetti, Austin, TX (US)

(21) Appl. No.: 14/455,198

(22) Filed: Aug. 8, 2014

(51) Int. Cl. G06F 17/30

(52) U.S. Cl. CPC G06F 17/30371

(57) ABSTRACT

A method of verifying data integrity comprising, storing data in a data storage system, scheduling an integrity check of at least a portion the data, wherein, scheduling the integrity check comprises determining when to perform the integrity check by accounting for a load on the storage system and taking into account any previous integrity checks of the at least a portion of the data. The method further comprises one of creating and updating an integrity status of the at least a portion of the data, with the integrity status comprising a reference to when the any previous integrity checks were performed on the at least a portion of the data and the integrity check was performed on the at least a portion of the data. The method further comprises providing the integrity status to a storage system user.

### FIELD OF THE INVENTION

The present invention relates to data integrity verification. In particular, but not by way of limitation, the present invention relates to scheduling one or more regular integrity checks of media data at an object level and reporting results.

### BACKGROUND OF THE INVENTION

The ability to ensure the integrity of data within a data storage system, such as, but not limited to, media data within a media data storage system, is an important aspect to the design, implementation and usage of any such system. Preventing data corruption and loss, and thereby ensuring the accuracy of the data which is stored, processed and/or retrieved over the entire life-cycle of the data and the system, ensures that the system may be operated efficiently and effectively. If the integrity of any portion of the stored data is called into question, the integrity of the entire system may be called into question, thereby decreasing the value of the system and the likelihood that the system will continue to be relied upon to store future data files. Data corruption and data loss, which may be as benign as a single pixel in an image appearing a different color as was originally recorded, or may comprise an entire loss of a stored data file, may occur as the result of malicious intent, unexpected hardware, software, or system failure, and/or human error. Such failure of integrity is often only determined when a storage, retrieval or processing operation is initiated, leading to delay and increased cost.

### SUMMARY OF THE INVENTION

In order to ensure the ongoing integrity of data stored in a system, a data integrity verification system has been created. One embodiment of such a system comprises a method of verifying data integrity. A first step of one such method comprises storing data in a data storage system, with a second step comprising scheduling an integrity check of at least a portion the data in the data storage system. For example, scheduling the integrity check may comprise determining when to perform the integrity check by accounting for a load on the storage system and taking into account any previous integrity checks of the at least a portion of the data. Additionally, the method may comprise at least one of creating and updating an integrity status of the at least a portion of the data. In one method, the integrity status may include a reference to a time and/or date of when (i) any previous integrity checks were performed on the at least a portion of the data, and (ii) the current integrity check was performed on the at least a portion of the data. The method may further comprise providing the integrity status to a storage system user.

Another embodiment of the invention may comprise a non-transitory, tangible computer readable storage medium, encoded with processor readable instructions to perform a method of verifying one or more instances of data objects. One such method comprises obtaining a first integrity verification of the one or more instances of data objects and obtaining a second integrity verification of the one or more instances of data objects, where the second integrity verification is obtained at a configurable time period measured from the first integrity verification, with at least one of the first integrity verification and the second integrity verification utilizing at least one of, any previous access of the one or more instances of data objects, a type of the of one or more instances of data objects, at least one of a category and a classification of the of one or more instances of data objects, and any previous access of an object instance that is adjacent to the one or more instances of data objects.

Yet another embodiment of the invention comprises a computing device. One computing device comprises a storage portion and one or more data objects located in the storage portion. The device further comprises an object integrity verification system adapted to verify the integrity of the one or more objects. Such integrity verification may occur during at least one of, transferring the one or more objects from a source and reading the one or more objects from the source.

The above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 depicts a method of verifying data integrity according to one embodiment of the invention;

FIG. 2 depicts a block diagram of a computing system according to one embodiment of the invention;

FIG. 3 depicts a computing device according to one embodiment of the invention;

FIG. 4 depicts a block diagram representing a data integrity verification process according to one embodiment of the invention;

FIG. 5 depicts a block diagram representing a data integrity verification process according to one embodiment of the invention;

FIG. 6 depicts a block diagram representing a data integrity verification process according to one embodiment of the invention;

FIG. 7 depicts a block diagram representing a data integrity verification process according to one embodiment of the invention.

### DETAILED DESCRIPTION

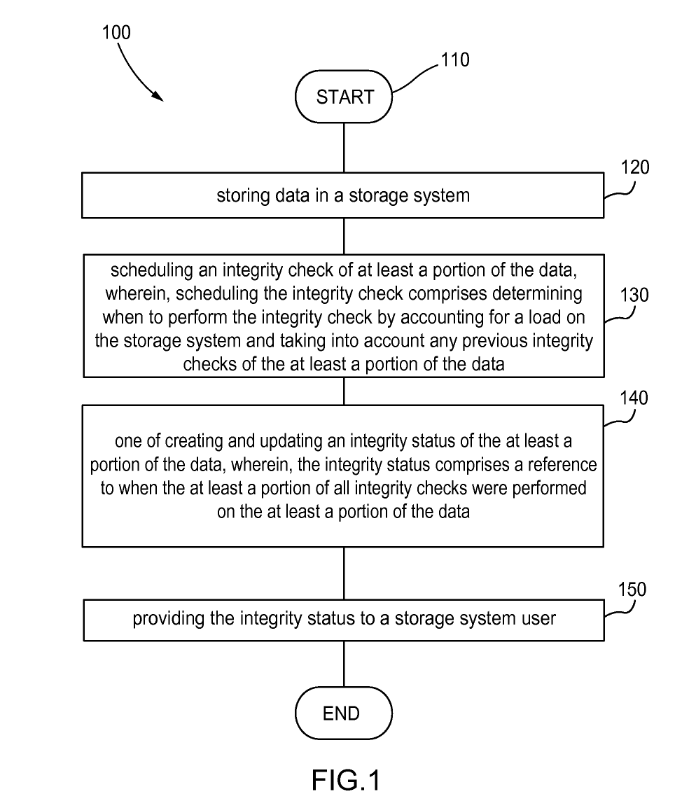

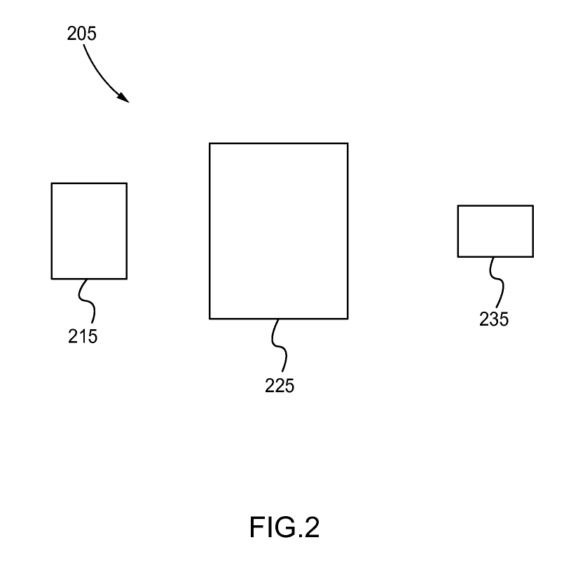

Turning first to FIG. 1, seen is a method 100 of verifying data integrity. The method 100 starts at 110 and at 120 comprises storing data in a storage system. For example, seen in FIG. 2 is one example of a storage system 205 comprising a first computing device 215, second computing device 225, and third computing device 235. One system 205 may comprise a content storage management (“CSM”) system. The first computing device 215 may comprise a user device such as, but not limited to a computing device adapted to view or otherwise access a media file. One media file may comprise a digital copy of a video. The second computing device 225 may comprise a media file server. For example, the second computing device 225 may be adapted to access one or more digital media files stored on the second computing device and/or may be adapted to access one or more media files stored on a third computing device 235. One third computing device 235 may comprises a tape library. It is contemplated that the one or more devices seen in FIG. 2 may comprise a single device or they may comprise additional devices.

In looking at FIGS. 1 and 2, in one embodiment, the method step of storing data in a storage system 120 may comprise placing a tape in a tape library at the third computing device 235 or may comprise saving a file to a memory location in the second computing device 225. Upon placing the data in the system 205, the method 100 at 130 comprises scheduling an integrity check of at least a portion the data. In one embodiment, scheduling the integrity check may comprise implementing in the second computing device 225 one or more automatic integrity checks of one or more portions of the data. One such integrity check may first determine when to perform the integrity check by accounting for a load on the storage system. For example, a processing load and/or a network load associated with the second computing device 225 or any other device in the system 205 may be taken into account. When such a load is calculated to be at a level below a specified threshold, the system 205 may implement an integrity check of the data. Alternatively, the system 205 may use the load to determine a time of day when the load is typically below a threshold and schedule the check for that time each day. This time of day may be recalculated and may change, as needed. Any excess load in the system 205 may be used by the system 205 issuing one or more low priority requests, while leaving load headroom for incoming requests.

In addition to taking into account a load, the system 205 may also take into account any previous integrity checks of the at least a portion of the data that the system 205 is scheduled to check. For example, the system 205 may implement one or more rules associated with the data. One such rule may be provided by the owner or other entity assigned to control any access of the data and may comprise ensuring that the integrity of the data is checked at least one time or not more than one time in any set time period (i.e., one month, 1 year, etc.). Such a rule and/or time period may be identified or referred to as a “delta point” for future integrity checks.

Though the storage system 205 data may comprise media files, it is also contemplated that the data may comprise one or more objects which may comprise at least a portion of one of the files or a file collection. It is also contemplated that the integrity check may be performed not on the media files themselves, but also, or in the alternative, on the files associated with the media files.

After a data integrity check has been scheduled, the integrity check may be run on the data. At step 140, in running the integrity check, an integrity status of the at least a portion of the data on which the check was run may be obtained. Alternatively, at step 140, if there is already a status file for the data, the status file may be updated. Such a status of the integrity of the data may be provided to a user or owner of the data. The status may inform the user or owner when each integrity check was performed on the data. Alternatively, the status may also inform the user or owner of when the data was otherwise accessed—for example, when the data was last copied to a user for playback. It is contemplated that if data was accessed within a specified time period, an integrity check may not be performed on the data. Upon creating a status of the integrity check, at step 150, the method 100 comprises providing the integrity check status to a storage system user such as, an owner.

In performing the integrity check of the data, the method may comprise detecting a failure of at least a portion of the data. For example, in checking the integrity of a digital copy of the data stored on the second computing device 225, a failure of at least a portion of the data may be detected. When a failure is detected in at least a portion of the data, the at least a portion of the data may be restored. This may occur by validating a separate instance of the at least a portion of the data. Such separate instance of the at least a portion of the data may be stored on the third computing device 235 and may comprise a tape. Upon validating the separate instance of the data, the data may be copied and/or otherwise restored on the second computing device 225.

In performing an integrity check on the data, the system 205 may implement one of checksums, hash algorithms, image fingerprinting, data patterns, and data sampling. For example, a checksum file may be created during the integrity check process for each, or for a plurality, of objects or object instances. Such a checksum file may be compared to a previously-obtained checksum file wherein the previously-obtained checksum file comprises a checksum file of a known valid object or object instance. Alternatively, one or more of the integrity verification processes described herein may be implemented to obtain a checksum or otherwise verify the integrity of the data. If the checksum files do not match, the integrity check may identify a failure in the data. Such checksums may comprise a value returned by the hash algorithm. Alternatively, or additionally, image fingerprinting may be used in the integrity check. Similar to using checksums, an original image fingerprint for one or more frames of a video or other media file may be compared with an image fingerprint created during the integrity check and if a difference between the two is detected, the integrity check may identify a failure in the data. Similar comparison of data patterns and/or data sampling may occur.

In implementing an integrity check, it is contemplated that an API may be used by a first computing device 215 or another computing device to query the integrity status of one or more instances of the data objects. For example, the delta point of the object may be first obtained and presented to the user prior to determine whether to implement the integrity check. A user may manually determine to pursue or not to pursue the integrity check upon receiving the delta point. Alternatively, the user may be informed of the delta point and that the integrity check is or is not automatically performed, based on the delta point. Such information user comprising the delta point and/or any error identified during the integrity check may be presented to the using one or more of the process described herein.

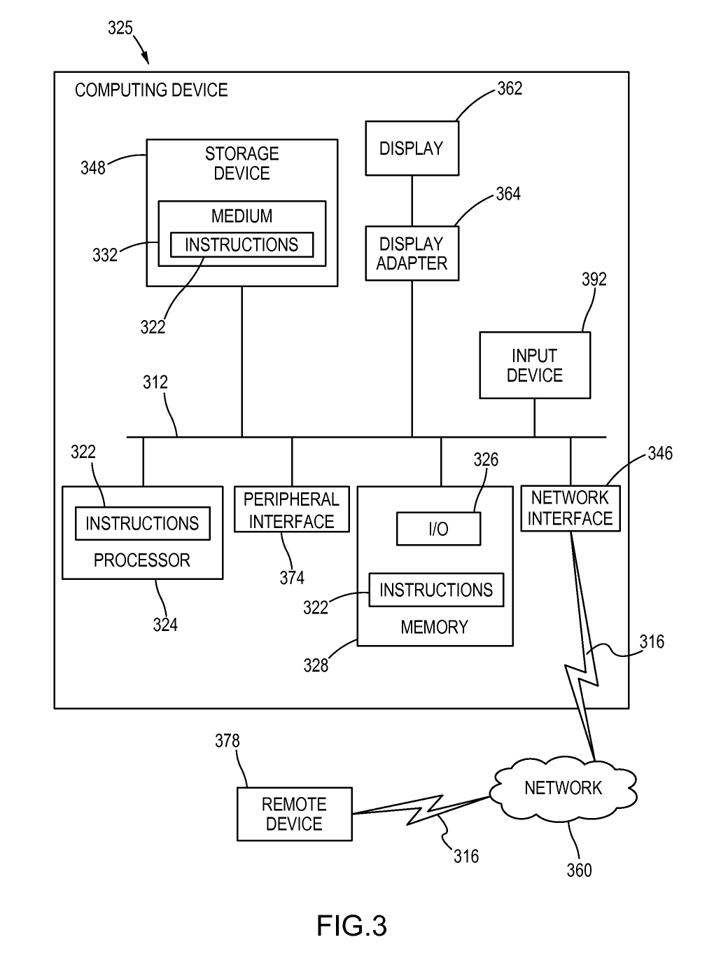

Turning now to FIG. 3, seen is diagrammatic representation of one embodiment of an exemplary form of the second computing device 325 or any other device comprising a portion of the system 205 seen in FIG. 2. Such a device 325 comprises one or more sets of instructions 322 for causing one or more system 205 devices to perform any one or more of the aspects and/or methodologies of the present disclosure. Device 325 includes the processor 324, which communicates with the memory 328 and with other components, via the bus 312. Bus 312 may include any of several types of bus structures including, but not limited to, a memory bus, a memory controller, a peripheral bus, a local bus, and any combinations thereof, using any of a variety of bus architectures.

Memory 328 may include various components (e.g., machine readable media) including, but not limited to, a random access memory component (e.g., a static RAM “SRAM”, a dynamic RAM “DRAM, etc.), a read only component, and any combinations thereof. In one example, a basic input/output system 326 (BIOS), including basic routines that help to transfer information between elements within device 325, such as during start-up, may be stored in memory 328. Memory 328 may also include (e.g., stored on one or more machine-readable media) instructions (e.g., software) 322 which may comprise the integrity check described herein, and may also comprise a non-transitory, tangible computer readable storage medium, and the instructions 322 may comprise processor 324 readable instructions 322 to perform, for example, a method of verifying the integrity of one or more instances of data objects. The instructions 22 may embody any one or more of the aspects and/or methodologies of the present disclosure. In another example, memory 328 may further include any number of program modules including, but not limited to, an operating system, one or more application programs, other program modules, program data, and any combinations thereof.

Device 325 may also include a storage device 348. Examples of a storage device (e.g., storage device 348) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 348 may be connected to bus 312 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 348 may be removably interfaced with device 325 (e.g., via an external port connector (not shown)). Particularly, storage device 348 and an associated machine-readable medium 332 may provide nonvolatile and/or volatile storage of machine-readable instructions 322, data structures, program modules, and/or other data for device 325. In one example, instructions 322 may reside, completely or partially, within machine-readable medium 332. In another example, instructions 322 may reside, completely or partially, within processor 324. Such instructions may comprise, at least partially, the instructions and methods mentioned herein.

Device 325 may also include an input device 392. In one example, a user of device 325 may enter commands and/or other information into device 325 via input device 392. Examples of an input device 392 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 392 may be interfaced to bus 312 via any of a variety of interfaces (not shown) including, but not limited to, a serial interface, a parallel interface, a game port, a USB interface, a FIREWIRE interface, a direct interface to bus 312, and any combinations thereof.

A user may also input commands and/or other information to device 325 via storage device 348 (e.g., a removable disk drive, a flash drive, etc.) and/or a network interface device 346. In one embodiment, the network interface device 346 may comprise a wireless transmitter/receiver and/or may be adapted to enable communication between the one or more of the first computing device 215, second computing device 225, and third computing device 235. The network interface device 346 may be utilized for connecting device 325 to one or more of a variety of networks 360 and a remote device 378. Examples of a network interface device 346 include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network may employ a wired and/or a wireless 316 mode of communication. In general, any network topology may be used. Information (e.g., data, software, etc.) may be communicated to and/or from device 325 via network interface device 346.

Computing device 325 may further include a video display adapter 364 for communicating a displayable image to a display device, such as display device 362. Examples of a display device include, but are not limited to, a liquid crystal display (LCD), a cathode ray tube (CRT), a plasma display, and any combinations thereof. In addition to a display device 362, device 325 may include one or more other peripheral output devices including, but not limited to, an audio speaker, a printer, and any combinations thereof. Such peripheral output devices may be connected to bus 312 via a peripheral interface 374. Examples of a peripheral interface include, but are not limited to, a serial port, a USB connection, a FIREWIRE connection, a parallel connection, and any combinations thereof. In one example, an audio device and display device 362 may provide audio and video, respectively, related to data of device 325 (e.g., data related to the integrity check).

A digitizer (not shown) and an accompanying stylus, if needed, may be included in order to digitally capture freehand input. A pen digitizer may be separately configured or coextensive with a display area of display device 362. Accordingly, a digitizer may be integrated with display device 362, or may exist as a separate device overlaying or otherwise appended to display device 362.

In one embodiment, one or more medium 332 may comprise a non-transitory, tangible computer readable storage medium 332, encoded with processor readable instructions 322 to perform a method of verifying the integrity of one or more instances of data objects. One such method may comprise obtaining a first integrity verification of the one or more instances of data objects. For example, using one or more of the checksums, hash algorithms, image fingerprinting, data patterns, and data sampling methodologies described herein, the integrity of one or more instances of data objects in the system 205 may be obtained upon loading or otherwise placing the one or more instances of data objects in the system 205. At a configurable point in time (e.g., the “delta point”) after obtaining the first integrity verification, a second verification of the integrity of the one or more instances of data objects may be obtained. Such integrity verifications may comprise checksums. The second integrity verification may be compared to the first integrity verification. If the second integrity verification is the same as the first integrity verification, the integrity of the data may be identified as valid with no failures. Either of the first or second verification may be implemented in a time-based job scheduler to operate at a specified time and may comprise determining which group the one or more instances of data objects belong to.

As described herein, prior to, or while performing, the first verification and/or the second verification of the one or more instances of data objects, the integrity verification process may determine whether any previous access of the one or more instances of data objects occurred. If so, the process may determine whether the access was (a) of a type and/or (b) within a timeframe which may delay, prevent or initiate an integrity verification process—either manually or automatically. Access may comprise (a) restoring the one or more instances of data objects, (b) re-packing the one or more instances of data objects, and/or (c) defragmenting the one or more instances of data objects.

Another factor that the integrity verification process may take into account prior to or during the process may comprise a type of the one or more instances of data objects. For example, for certain object types, the verification process may be set to automatically run at a time period (e.g., a delta point of six months) different than a time period (e.g. a delta point of 1 year) for a different object type. It is also contemplated that at least one of an object category and/or an object classification of the one or more instances of data objects may be taken into account in the integrity verification process. For example, the process may use such information in determining when to schedule and/or otherwise run the process as the process may be run more frequently on some object classes/classifications than others. It is yet further contemplated that the process may take into account any previous access of an object instance that is adjacent to the one or more instances of data objects. For example, if only a first portion of a tape is viewed at a first time and a data integrity verification on a second portion of the tape is sought at a second time after the first, the process may determine whether enough time elapsed between the first time and the second time before initiating the process.

It is contemplated that upon running and comparing the first data integrity verification process and the second data integrity verification process, one or more failures may be found. If so, any failed data may be restored by creating a restoration file at a designated file location. Such a restoration file may comprise a new data file copied from a known valid data file. For example, restoring the one or more instances of data objects may comprise automatically validating a new data object copied from a tape. Upon verifying the integrity of the new data file, the new data file may replace the failed data file and the restoration file may be deleted after the new data filed is replaced. In one embodiment, the designated file location comprises a location wherein the file is adapted to discard all data written to the file after verifying the restoration is accurate and report that a write operation has succeeded. Such a location may comprise a/dev/null location in a UNIX of UNIX-like operating system, or any other null device in any operating system.

In one embodiment, the device 325 seen in FIG. 3 comprises a storage portion such as, but not limited to, the storage device 348 and/or memory 328. One or more objects may be located in the storage portion. Furthermore, the instructions 322 may comprise an object integrity verification system adapted to verify the integrity of the one or more objects. For example, such verification may occur during transferring of the one or more objects to or from a source such as, but not limited to, the third computing device 235 seen in FIG. 2. Or, the verification may occur, for example, during reading of one or more objects from the source.

In one embodiment, reading of one or more objects from the source may comprise calculating an on-the-fly checksum for the one or more objects as the one or more objects are being read from the source. Reading of one or more objects from the source may also comprise performing checksum verification by determining whether a calculated checksum matches a checksum attached to the one or more objects. Furthermore, reading of the one or more objects from the source may be designated as successful when the calculated checksum matches the checksum attached to the one or more objects. One source may comprise a storage medium.

In one embodiment, at least part of the storage portion may comprise a tape, with one or more objects being located on the tape. In such an embodiment, when the object integrity verification system verifies the integrity of one of the one or more objects, or otherwise accesses at least one of the objects, the integrity of a remaining of the one or more objects located on the same tape may be verified.

The object integrity verification system 205 may be adapted to determine when to verify the integrity of the one or more objects by utilizing at least one of, (i) a mean time between failure, (ii) metadata asset value, (iii) frequency of object use, (iv) a duty cycle for a device type, (v) at least one external triggers, which may comprise a trigger from at lease of an API and a user interface, (vi) one or more environmental conditions such as, but not limited to, temperature, humidity, and pressure, (vii) seismic activity, (viii) geolocation information, (ix) at least one of a storage media type (e.g., tape, disk, optical, etc.), generation, age, and recycle count, (x) a number of copies of the objects in the system 205, (xi) any related verification failures (file/object verification failed for media from the same batch or an object stored on the same day on the same device, etc.), and (xi) randomization algorithms. The object integrity verification system may further implements a checksum algorithm type comprising at least one of following: (a) message digest algorithm 2, (b) modification detection code 2, (c) message digest algorithm 5, (d) secure hash algorithm, (e) secure hash algorithm-1, (f) RACE integrity primitives evaluation message digest, (g) genuine checksum, and (h) deferred checksum.

One embodiment may comprise the following instantiation routine invoked via an API or a command-line interface:

```
module Diva
    module HealthCheck
        class InstanceCheck
            attr_accessor :diva
            def initialize(options = { })
                @diva = options[:diva]
            end
            def instances_older_than(date, options = { })
                date = date.to_i # just make sure we have an int
                instances_to_return = [ ]
                r_instance_id = 0
                begin
                    result =
diva.make_request(:getobject_instance_checksum_date,
{“r_instance_id” => r_instance_id, “r_size” => 100})
                    instances =
confirm_array(result.data[:key])
                    instances_to_return += instances.select
{|i| i[:checksum_verify_date].to_i < date }
                    r_instance_id =
instances.last[:instance_id].to_i if instances.size > 0
                end while instances.size > 0 && ((options[:limit]
&& instances_to_return.size < options[:limit]) || !options[:limit])
                options[:limit] ?
instances_to_return.first(options[:limit]) : instances_to_return
        end
```

Similarly, one embodiment may also come the following verification routine invoked via an API or a command-line interface:

```
module Diva
    module HealthCheck
        class VerifyChecksum
            attr_accessor :diva
            def initialize(options = { })
                @diva = options[:diva]
                @restore_destination = options[: restore]
            End
            def verify_instances(instances)
                instances.map {|i|
verify_instance(i[:object_name], i[:category], i[:instance_id])}
            end
            private
            def session_code
                @session_code ||=
@diva.make_request(:register_client, {appName: “healthcheck”,
locName: “lynx”, processId: Time.now.to_i}).data
            end
            def verify_instance(name, category, instance_id)
                @session_code ||=
    @diva.make_request(:register_client, {appName: “healthcheck”,
    locName: “lynx”, processId: Time.now.to_i}).data
                response = @diva.make_request(:restoreInstance,
    {sessionCode: @session_code, objectName: name, objectCategory:
    category, instanceID: instance_id, destination:
    @restore_destination, filesPathRoot: “”, qualityOfService: 0,
    priorityLevel: 25, restoreOptions: nil})
                if response.success?
                    return response.data[:request_number].to_i
                else
                    return “error:#{response.status}”
    end
```

One embodiment may comprise a command line tool supporting the following options:

Usage: check_instances.rb [options]

| | |
|---|---|
| -h, --help | Display the Help screen |
| -l, --log | Pumps output to console |
| -d, --diva HOST | Diva Hostname ex: |
| | http://172.20.128.101:9763 |
| -m, --max REQUESTS | How many requests can the system |
| | handle |
| -r, --restore DESTINATION | The restore destination to pass |
| | to diva |
| -g, --group GROUP | The name of the group to care |
| | about for checking instances |
| -w, --weeks WEEKS | The number of weeks to go back |
| | for instances checks |

Checksum algorithms supported by a system 205 such as, but not limited to, the DIVArchive® content storage management (“CSM”) system of Front Porch Digital of Lafayette, Colo. may comprise the following algorithms seen in Table 1:

TABLE 1

| Term | Definition |
|---|---|
| Checksum | Message Digest Algorithm 2 (MD2): A cryptographic hash function. |
| Algorithm: | The algorithm is optimized for 8-bit computers which remains in use in |
| MD2 | public key infrastructures as part of certificates generated with MD2 and |
| | RSA. |
| Checksum | Modification Detection Code 2: In cryptography MDC2 (sometimes |
| Algorithm: | called Meyer-Schilling) is a cryptographic hash function with a 128-bit |
| MDC2 | hash value. MDC-2 is a hash function based on a block cipher with a |
| | proof of security in the ideal-cipher model. |
| Checksum | Message Digest Algorithm 5: MD5 is a cryptographic hash function |
| Algorithm: | with a 128-bit hash value. MD5 is employed in a wide variety of security |
| MD5 | applications and is commonly used to check the integrity of files. |
| | MD5 is a default DIVArchive ® Checksum Type. |
| Checksum | Secure Hash Algorithm: A cryptographic hash function. |
| Algorithm: | |
| SHA | |
| Checksum | Secure Hash Algorithm-1: A 160-bit hash function which resembles the |
| Algorithm: | MD5 algorithm. SHA-1 is a default SAMMA ® Solo Checksum Type. |
| SHA-1 | |
| Checksum | RACE Integrity Primitives Evaluation Message Digest: A 160-bit |
| Algorithm: | message digest algorithm (cryptographic hash function). It is an |
| RIPEMD160 | improved version of RIPEMD, which was based upon the design |
| | principles used in MD4, and is similar in performance to the more |
| | popular SHA-1. |

If an object comprises multiple files (i.e., components or objects), a checksum may be generated and later verified for each of the component elements. Three checksum types and checksum sources may be implemented, as seen in Table 2:

TABLE 2

| | |
|---|---|
| Genuine | This checksum may be provided through the API in an archive |
| Checksum (GC) | request, or retrieved by a system 205 device from a Source/Destination |
| | location. The GC may ensure maximum security as it allows the |
| | system 205 to verify all transfers to and within the archive system. |
| | The GC maybe obtained before the archive starts. It may either be |
| | passed in an archiveObject API function, or, for example, obtained |
| | from the Source/Destination location by an Actor device using an API |
| | provided by the Source/Destination manufacturer. |
| | This checksum may be obtained during the Archive Request. |
| Archive Checksum | This checksum may be generated during a transfer phase into the |
| (AC) | system 205 and may be based on the data that is received from the |
| | network (for networked sources), calculated during the actual transfer, |
| | or read from the device (for disk type sources). This type of checksum |
| | may not detect corruptions which occurred during the transfer from the |
| | Source/Destination to the Actor device, but all other subsequent |
| | corruptions may be detected. |
| | The AC may be calculated during data transferred through the Actor |
| | on-the-fly at the point before it is written to disk, or other storage |
| | medium, within the system 205. |
| | This checksum may be generated during the Archive Request. |
| Deferred | This checksum may be generated during the read of an object already |
| Checksum (DC) | stored in the archive system 205 which has no checksum previously |
| | associated with it, potentially because the previous system 205 version |
| | did not support it, or the option was not activated. |
| | This type of checksum may not allow corruption detection that |
| | occurred at an earlier stage (e.g. during the archive or further data |
| | movement within a copy or repack process). However, it may allow |
| | corruption detection in all further data processing. |
| | This checksum may be generated during requests on existing objects. |
| | (Ex: Copy Request, Restore Request, etc.) |

At least a portion of any one or more of a plurality of workflows may be used to implement a data integrity verification process. Seen in Table 3 are four such workflows:

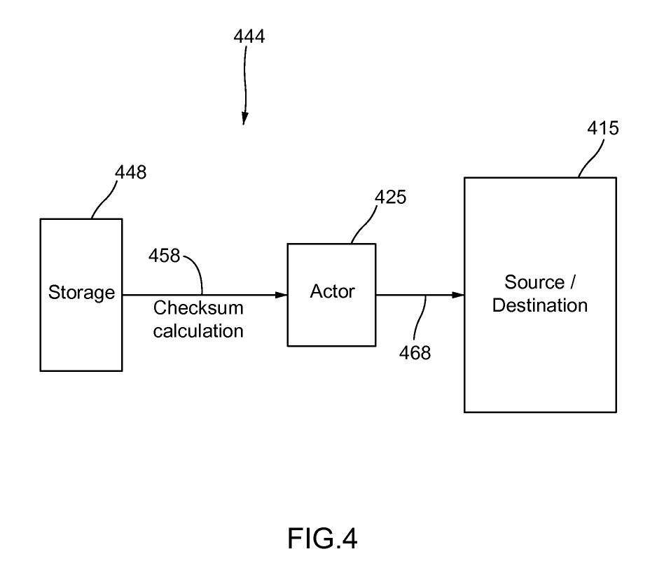

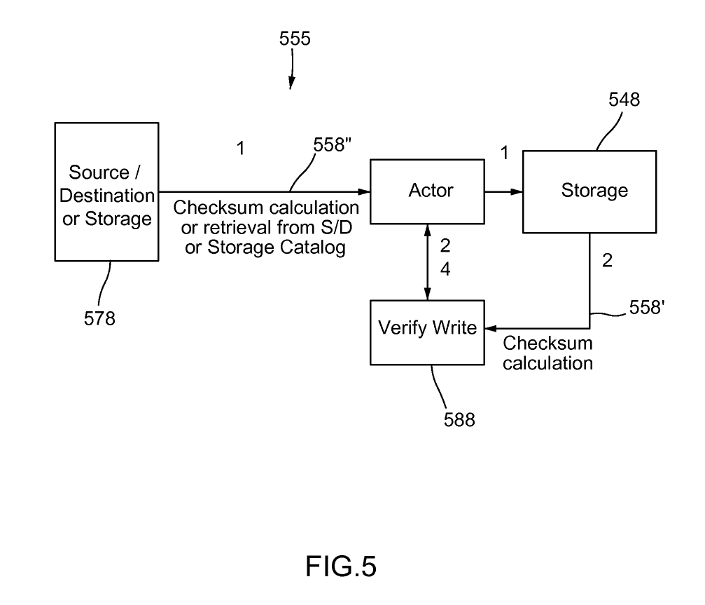

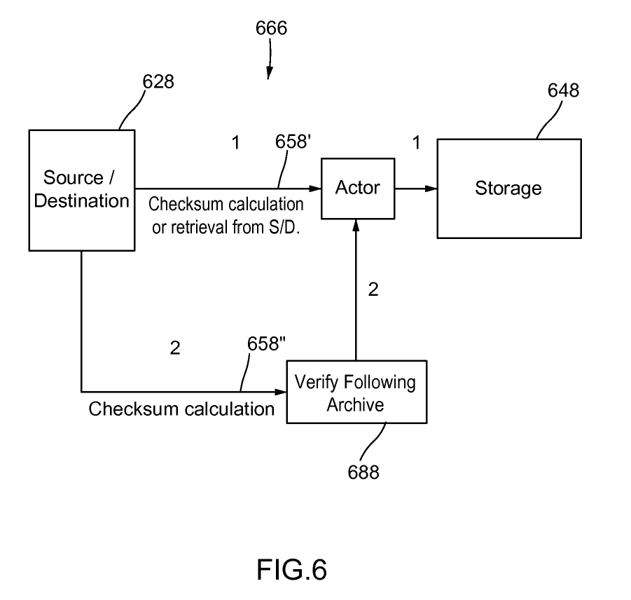

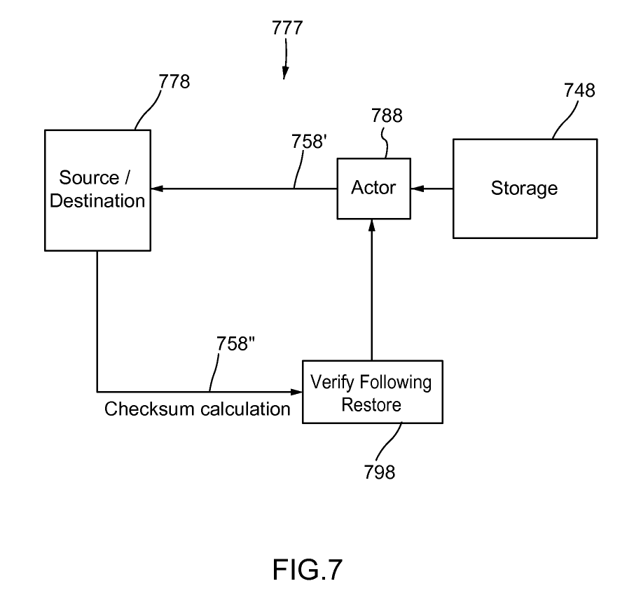

TABLE 3

| | |
|---|---|
| Default | Turning now to FIG. 4, seen is a data integrity verification process comprising |
| Workflow/ | a verify read workflow 444. One verify read workflow 444 may calculate on- |
| Verify Read | the-fly checksums for content as it is being read from a storage device 448. |
| (VR) | For example, the first computing device 215 seen in FIG. 2 may request a |
| | media file from the second computing device 225. The second computing |
| | device 225 may request the media from the third device 235. Upon receiving |
| | the media file from the third computing device 235 (the storage device 448), |
| | the second computing device 235 in the content storage management (“CSM”) |
| | system 205 that may comprise a DIVArchive ® CSM system of Front Porch |
| | Digital of Lafayette, CO, or any other portion of the system 205, may perform |
| | the checksum calculation 458 on the file. The calculated checksum may be |
| | received at another (or the same) portion of the second computing device 425, |
| | which may perform a verification of the calculated checksum by comparing |
| | the calculated checksum to a saved checksum of the same media file. |
| | After such a full read operation is complete and the calculated checksum |
| | matches the checksum attached to the stored data, the operation may be |
| | considered successful and the media file may be sent 468 to the destination |
| | which comprise the first computing device 415. |
| Verify Write | Turning now to FIG. 5, seen is another data integrity verification process |
| (VW) | comprising a verify write workflow 555. In one verify write workflow 555, |
| | data may be placed in the storage 548. Upon the data being placed in the |
| | storage 548, the data may be read and a first checksum calculation 558′ may |
| | be performed on the data. A second checksum calculation 558″ may be |
| | performed or otherwise obtained from a source file 578. The two checksums |
| | may then be compared at the verify write 588 process. Under the verify write |
| | workflow 555, the write operation (i.e., storage of the data) may be deemed |
| | successful when the full read operation is complete and the calculated |
| | checksum matches the checksum of the incoming data. This read-back data |
| | may then be discarded. |
| Verify | Turning now to FIG. 6, seen is another data integrity verification process |
| Following | comprising a verify following archive workflow 666. In one verify following |
| Archive (VFA) | archive workflow 666 process, upon copying data from a source location 678 |
| | such as, but not limited to, from a tape at a first third device 235, to a storage |
| | location 648 such as, but not limited to, a digital storage location at a second |
| | third device 235, a first checksum calculation 658′ may be conducted. The |
| | data may be re-transferred the source device 678 after the initial archive |
| | operation and a new checksum calculation 658″ may be conducted and |
| | compared 668 against the previously calculated and/or an archived checksum. |
| | The original archive operation is deemed successful when the re-transfer (i.e., |
| | second transfer) is fully complete and the checksums are identical. |
| Verify | Turning now to FIG. 7, seen is another data integrity verification process |
| Following | comprising a verify following restore workflow 777. In one verify following |
| Restore (VFR) | restore workflow 777, data is first restored from a storage 748 to a destination |
| | 778 through an actor 788 which may comprise a second computing device |
| | 225. The data is then re-transferred from the source device 778 after the initial |
| | restore operation to, for example a verify device 798, which may comprise a |
| | portion of the actor 788. A first checksum calculation 758′ may be obtained |
| | during the initial restore and may be compared to a second checksum |
| | calculation 758″ obtained during or otherwise from the restored data. This |
| | restore operation is successful when the second transfer is fully complete and |
| | the checksums are identical. |

Each workflow seen in Table 3 may be used with one or several requests. Table 4 shows which workflows/checksum support may work with various requests. A “Y” in Table 4 means that the workflow may be supported for that request (and vice versa), a “Y (DEFAULT)” means that it may be supported by default, an empty cell means that it may not be supported or not applicable, while a *T means that it may be supported with change in object format.

TABLE 4

| REQUESTS/ | | | | Partial | | Copy As | Associative |
|---|---|---|---|---|---|---|---|
| WORKFLOWS | Archive | Restore | N-Restore | Restore | Copy | New | Copy |
| Default | Y | Y | Y | | Y | Y | Y |
| Workflow/ | (DEFAULT) | (DEFAULT) | (DEFAULT) | | (DEFAULT) | (DEFAULT) | (DEFAULT) |
| Verify Read | | | | | | | |
| Genuine | Y | | | | | | |
| Checksum (1) | | | | | | | |
| Verify- | Y | | | | | | |
| Following- | | | | | | | |
| Archive (1) (3) | | | | | | | |
| Verify Write (2) | Y | | | | Y | Y | Y |
| Verify- | | Y | | | | | |
| Following- | | | | | | | |
| Restore (3) | | | | | | | |
| SAMMA solo | Y | | | | | | |
| Integration | | | | | | | |
| Export | | | | | | | |
| Content with | | | | | | | |
| Checksum | | | | | | | |
| Import | | | | | | | |
| content with | | | | | | | |
| Checksum | | | | | | | |

| REQUESTS/ | Verify | Repack | | | Transcoding Operation |
|---|---|---|---|---|---|
| WORKFLOWS | Tapes | Tapes | Export | Import | (Archive, Restore, Copy) |
| Default | Y | Y | | | *T |
| Workflow/ | (DEFAULT) | (DEFAULT) | | | |
| Verify Read | | | | | |
| Genuine | | | | | *T |
| Checksum (1) | | | | | |
| Verify- | | Y | | | |
| Following- | | | | | |
| Archive (1) (3) | | | | | |
| Verify Write (2) | | | | | |
| Verify- | | | | | |
| Following- | | | | | |
| Restore (3) | | | | | |
| SAMMA solo | | | | | |
| Integration | | | | | |
| Export | | | Y | | |
| Content with | | | (DEFAULT) | | |
| Checksum | | | | | |
| Import | | | | Y | |
| content with | | | | (DEFAULT) | |
| Checksum | | | | | |

The checksum workflows described herein may support non-complex objects. However, the Verify Write (VW) may also support complex objects. Because Complex Object checksums are stored in the Metadata Database rather than the Oracle Database, they will not be displayed in any Database Queries, and the getObjectInfo API call will return a phony checksum and not all files and folders will be displayed (only a single file representing the entire Complex Object).

If Checksum Support is disabled when a Complex Object is archived, and then subsequently enabled, there will be no checksum comparison during operations on the Complex Object. In other words, whatever checksum is used when the Complex Object is archived, will be the checksum used throughout the life of the object

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method of verifying data integrity comprising,
storing data in a data storage system;
scheduling a first integrity check of at least a portion the data in the data storage system, wherein, scheduling the integrity check comprises,
determining when to perform the first integrity check by accounting for a load on the storage system, and
taking into account any previous integrity checks of the at least a portion of the data;
one of creating and updating an integrity status of the at least a portion of the data, wherein, the integrity status comprises a reference to when the,
any previous integrity checks were performed on the at least a portion of the data, and
the first integrity check was performed on the at least a portion of the data; and
providing the integrity status to a storage system user.

2. The method of claim 1 wherein, the data comprises at least one object comprising at least a portion of a,
file; and
file collection.

3. The method of claim 1 wherein, scheduling a first integrity check of the data comprises establishing an automatic verification of data integrity.

4. The method of claim 1 wherein, taking into account any previous integrity checks of the at least a portion of the data comprises implementing one or more rules referencing the at least a portion of the data.

5. The method of claim 1 further comprising,
detecting a failure of at least a portion of the data; and
at least one of,
validating a separate instance of the at least a portion of the data, and
restoring the at least a portion of the data.

6. The method of claim 1 wherein, the integrity check of at least a portion the data comprises using at least one of,
checksums and hash algorithms;
image fingerprinting;
data patterns; and
data sampling.

7. The method of claim 1 wherein, providing the integrity status to a data storage system user comprises providing a delta point for future integrity checks; and
further comprising,
using an API to query the integrity status and obtain the delta point, and
updating a table comprising the delta point when encountering a checksum error during the first integrity check.

8. A non-transitory, tangible computer readable storage medium, encoded with processor readable instructions to perform a method of verifying an integrity of one or more instances of data objects comprising,
obtaining a first integrity verification of the one or more instances of data objects; and
obtaining a second integrity verification of the one or more instances of data objects, wherein the second integrity verification is obtained at a configurable time period measured from the first integrity verification, wherein,
at least one of the first integrity verification and the second integrity verification comprises utilizing at least one of,
any previous access of the one or more instances of data objects,
a type of the of one or more instances of data objects,
at least one of a category and a classification of the of one or more instances of data objects, and
any previous access of an object instance that is adjacent to the one or more instances of data objects.

9. The non-transitory, tangible computer readable storage medium of claim 8 wherein, the previous access of the one or more instances of data objects comprises at least one of,
restoring the one or more instances of data objects;
re-packing the one or more instances of data objects; and
defragmenting the one or more instances of data objects.

10. The non-transitory, tangible computer readable storage medium of claim 9 wherein, restoring the one or more instances of data objects comprises automatically validating a new data object copy from a tape.

11. The non-transitory, tangible computer readable storage medium of claim 8 wherein, the previous access of an object instance that is adjacent to the one or more instances of data objects comprises a time since a last access of an object on a same tape as the one or more instances of data objects.

12. The non-transitory, tangible computer readable storage medium of claim 8, wherein, at least one of obtaining the first verification and second verification comprises restoring the data by creating a restoration file at a designated file location; and further comprising,
deleting the restoration file after obtaining the at least one of the first verification and the second verification.

13. The non-transitory, tangible computer readable storage medium of claim 12, wherein the designated file location comprises a file adapted to,
discard all data written to the file; and
report that a write operation has succeeded.

14. The non-transitory, tangible computer readable storage medium of claim 8 wherein, at least one of obtaining a first verification of the integrity of the one or more instances of data objects and obtaining a second verification of the integrity of the one or more instances of data objects comprises,
implementing the verification in a time-based job scheduler to operate at a specified time; and
determining which group the one or more instances of data objects belong to.

15. The non-transitory, tangible computer readable storage medium of claim 8 further comprising,
determining when to obtain at least one of the first verification and the second verification by accounting for a load on the storage system;
filling up a portion of any excess load with one or more low priority requests; and
leaving load headroom for incoming requests.

16. A computing device comprising,
a storage portion;
one or more objects located in the storage portion;
an object integrity verification system adapted to verify the integrity of the one or more objects when at least one of,
transferring the one or more objects from a source, and
reading the one or more objects from the source.

17. The device of claim 16, wherein, reading the one or more objects from the source comprises,
calculating an on-the-fly checksum for the one or more objects as the one or more objects are being read from the source;
performing checksum verification by determining whether the on-the-fly checksum matches a previously-obtained checksum referencing the one or more objects; and
designating reading the one or more objects from the source as successful when the on-the-fly checksum matches the previously-obtained checksum.

18. The device of claim 16 wherein,
at least a portion of the,
storage portion comprises a tape, and
one or more objects are located on the tape;
the object verification system is further adapted to, verify the integrity of a remaining of the one or more objects located on the same source when the object integrity verification system verifies the integrity of one of the one or more objects on the same source; and
the source comprises a storage medium.

19. The device of claim 16, wherein, the object integrity verification system is adapted to in determine when to verify the integrity of the one or more objects by utilizing at least one of,
a mean time between failure;
metadata asset value;
frequency of object use;
a duty cycle for a device type;
at least one external triggers;
one or more environmental conditions;
seismic activity;
geolocation information;
at least one of a storage media type, generation, age, and recycle count;
number of copies of the objects;
related verification failures (file/object verification failed for media from the same batch or an object stored on the same day on the same device, etc.); and
randomization algorithms.

20. The device of claim 16 wherein, the object integrity verification system implements a checksum algorithm type comprising at least one of a,
message digest algorithm 2;
modification detection code 2;
message digest algorithm 5;
secure hash algorithm;
secure hash algorithm-1;
RACE integrity primitives evaluation message digest;
genuine checksum; and
deferred checksum.

21. The device of claim 16 wherein at least one of,
the external trigger comprises at least one of a trigger from a user interface; or API control
the environmental controls comprise (temperature, humidity, pressure, etc.)
storage media type comprises (tape, disk, optical, etc.)
